(19) United States
(12) Patent Application Publication
(10) Pub. No.: US 2008/0152819 A1
(43) Pub. Date: Jun. 26, 2008

(54) Device And Process For Coating Workpieces

(76) Inventors: Achim Gauss, Dornstetten (DE); Ludwig Albrecht, Dornstetten-Aach (DE); Karl Frey, Schopfloch (DE)

Correspondence Address: BAKER BOTTS L.L.P., 30 ROCKEFELLER PLAZA, 44TH FLOOR, NEW YORK, NY, 10112-4498, US

(21) Appl. No.: 11/960,121

(22) Filed: Dec. 19, 2007

(30) Foreign Application Priority Data
Dec. 20, 2006 (EP) 06 026 431.4

(51) Int. Cl. B05D 7/08; B05D 1/02; B05B 9/04

(52) U.S. Cl. 427/408; 427/427.3; 427/417; 239/373; 239/569

(57) ABSTRACT

The invention relates to a device for coating workpieces which preferably consist at least partially of wood, wood-based materials, synthetic material or the like, said device comprising an application means for applying a curable mass, in particular a varnish, and a conveying device for causing a relative movement between said application means and the respective workpiece. The device according to the invention is characterized in that said application means has at least one micro-nozzle for applying said curable mass, and preferably at least one micro-valve.

### FIELD OF THE INVENTION

The invention relates to a device for coating workpieces which preferably consist at least partially of wood, wood-based materials, synthetic material or the like, according to the preamble of claim 1 as well as to a process using this device.

### PRIOR ART

Various techniques are known for coating workpieces which consist, e.g., at least partially of wood, wood-based materials, synthetic material or the like. A requirement recently made in the field of flooring production is to coat and decorate, in the case of flooring panels such as ready-to-use parquet or laminate, a so-called “mini-chamfer”. The arrangement of such a mini-chamfer 2′ on a flooring panel (workpiece) 2 is schematically shown, purely as an example, in FIG. 3.

The mini-chamfer is normally produced by milling the respective flooring panel. Before being decorated (e.g. printed on), the milled surface must be provided with a coating, e.g. a primer. This is presently often carried out using so-called Vacumat technology, which is offered, e.g., by Schiele (www.schiele-maschinenbau.de). In this method, however, the varnish coating cannot be applied with particularly good edge definition due to the removal of the varnish by suction and the air turbulence. It is only possible to apply one specific colour which is close to the base colour of the surface decoration. Generally, a large amount of varnish is in the circulation of the Vacumat device. High losses of varnish occur during a change of paint or varnish due to the necessary rinsing processes of the system components. The Vacumat technology itself has high energy consumption due, on the one hand, to the generation of the vacuum and, on the other, to the power which has to be supplied to dry the varnish, and the system costs are relatively high.

Alternatively, it is also known to apply an embossing film to the respective mini-chamfer. Coating with embossing film has the main advantage that swelling of the milled basic material is avoided. However, so that they can be processed in a reliable manner, the embossing films are only available as centimetre-wide films, even though in many cases of use only a few millimetres are required. This leads to high material waste. The peripheral zones of the coating region are not very well defined at the edges, as was the case for the application with Vacumat, since the tearing forces are not clear. A further disadvantage is the storage of the many different decorations required that match the decorative surface as well as the relatively high set-up times for changing a decoration.

### SUMMARY OF THE INVENTION

It is therefore an object of the invention to provide a device of the aforementioned type, which allows a simple yet precise and high-quality coating of workpieces, in particular in the region of narrow or partial surfaces, as well as to provide a process herefor.

This object is solved in accordance with the invention by a device according to claim 1 and a process using the device of the invention according to claim 12.

Particularly preferred embodiments of the invention are the subject matter of the dependant claims.

The idea underlying the invention is a new development for a device of the aforesaid type, in which known techniques which were developed for components with large surfaces are not just simply adapted for coating narrow or partial surfaces. For this purpose, it is provided in accordance with the invention that in the case of a device of the aforesaid type, the application means has at least one micro-nozzle for applying the curable mass, and preferably at least one micro-valve.

The provision of at least one micro-nozzle makes it possible to apply the curable mass to the respective surface section of the workpiece in a targeted and edge-defined manner, without a complicated or expensive arrangement being required herefor. Although the process for ejecting the curable mass out of the micro-nozzles can, in principle, be actuated and controlled in any manner within the scope of the present invention, a main objective of the invention is that the application means comprises at least one micro-valve. Thus, it has become apparent that this type of supply and control of the curable mass in conjunction with an associated micro-nozzle is particularly suitable for varnishes and similar coating substances since a precise and simple controllability with a good response behaviour is obtained. The respective micro-valve furthermore prevents undesired curing of the available, curable mass with low maintenance costs and a long service life.

According to an embodiment of the invention, it is provided that the application means has at least one pressurized store of curable mass. This allows for particularly good reaction behaviour and a high throughput of the device according to the invention since just one micro-valve has to be opened by a suitable current pulse or the like for a coating process.

It can thereby be sufficient in many cases that the pressurized store has a comparatively low volume and that, in addition, an actual storage container is provided, which supplies the pressurized store with curable mass and does not necessarily have to be under pressure itself. On the other hand, the pressurized store can also have a large volume and/or can be arranged for the most part at a position which is disposed at a distance from the respective micro-nozzle. The pressurized store can thereby be loaded, e.g., by an injection piston, which defines a desired pressure and can also ensure the removal of air bubbles or the like so as to obtain a high setting accuracy of the pressure and the ejection amount. It is moreover possible to deduce that there are possible clogged micro-nozzles by way of such an injection piston.

In view of the high variability and adaptability of the device according to the invention, it is provided according to an embodiment that the application means has at least one micro-valve per micro-nozzle. As a result thereof, the type of coating as well as the coating region can be variably adjusted.

Within the scope of the present invention, the micro-valves can be designed in various different manners, with the use of solenoid micro-valves having proved to be particularly advantageous since they can be controlled and operated in a particularly easy and precise manner.

The respective micro-valve is thereby arranged advantageously between the at least one, preferably pressurized, store of curable mass and the at least one micro-nozzle.

The dimensions of the micro-nozzle (and the nozzle opening) are not particularly restricted within the scope of the present invention and can rather be selected depending on the respective requirements such as, in particular, the type and viscosity of the curable mass to be applied, the necessary flow-rate, the desired application accuracy and/or resolution, etc. For the cases of use which are preferred within the scope of the present invention such as, for instance, the coating of mini-chamfers, it has proved to be advantageous, however, that the at least one micro-nozzle has a diameter of at least 50 μm, preferably at least 100 μm. As a result of this, varnishes and similar curable masses can be reliably and rapidly applied to the workpieces with a sufficient flow-rate. On the other hand, the nozzle diameter should not be selected such it is too large either since otherwise, e.g., the edge definition will be negatively affected. Against this background, it is provided according to an embodiment of the invention that the at least one micro-nozzle has a maximum diameter of 300 μm, preferably 200 μm.

To furthermore obtain a homogeneous coating over the whole area of the respective workpiece surfaces, it is provided according to an embodiment of the invention that said device comprises a plurality of micro-nozzles which are preferably arranged in an offset manner in the direction of a relative movement between the application means and the respective workpiece.

During milling of the workpieces or similar preceding machining steps, a porous and absorbent surface to be coated is often produced depending on the material of the workpiece. To prepare the surface to be coated for the subsequent coating and also, for instance, to reduce its absorption capability and/or compensate for any unevenness, it is provided according to an embodiment of the invention that the device further comprises a smoothing means for smoothing a surface of the respective workpiece which is to be provided with the curable mass.

The smoothing means can, as will become more clear from the detailed description below, be formed in different ways, e.g. as a thermal-transfer smoothing means. It is achieved thereby that the workpiece surface is sealed and a swelling of the material is avoided. Furthermore, by introducing heat, the subsequent curing of a curable material is assisted in many cases. Finally, the curable mass can no longer penetrate the material, or can only penetrate it to a lesser extent, which leads to a lower consumption of curable mass.

The application means can, in principle, also be designed within the scope of the present invention to not only apply single-coloured, but also patterned coatings to the respective workpiece. Due to the high quality requirements placed on the respective print image (e.g. of a wood grain) it has, however, proved to be advantageous to provide a separate printing device for applying a pattern, in particular an ink-jet printing means. To prepare the surface of the coating material applied by the application means for subsequent printing, the device according to the invention can further comprise a pre-treatment means such as, is disclosed and claimed, for instance, in the European patent application EP 06 004 713.1 of the present Applicant, and reference is herewith explicitly made to the entire disclosure thereof.

In this context it can also be important that the applied coating material is largely cured before the subsequent printing process. For this purpose, it is provided according to an embodiment of the invention that the device further comprises at least one curing means, in particular at least one NIR-curing means and/or at least one UV-curing means. The NIR-curing means is primarily used for the curable coating mass, whereas a UV-curing means is primarily used to cure and/or dry an ink or the like applied by the printing means.

A particularly advantageous process for coating workpieces using the device described above is the subject matter of claim 12. The advantages described above can achieved particularly well with this process. It is particularly preferred thereby that the surface region of the respective workpiece is first of all preferably machined by way of cutting and is particularly preferred also pre-treated, in particular smoothened, and that at least the machined and, optionally, pre-treated region is coated at least in sections with said curable mass. Alternatively or in addition, it is provided according to an embodiment of the process according to the invention that the workpiece is substantially plate- or strip-shaped, and that said workpiece is coated in sections with said curable mass at least in the region of a narrow surface, said narrow surface preferably being at an angle with respect to a large surface of said workpiece.

### BRIEF DESCRIPTION OF THE DRAWINGS

FIG. 1 shows a schematic view of a coating device as preferred embodiment of the present invention;

FIG. 2 shows a schematic partial view of the device of FIG. 1;

FIG. 3 schematically shows two connected workpieces, which are suitable to be machined by the device according to the invention.

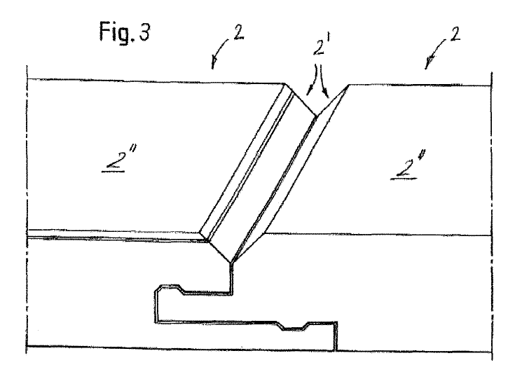

### DETAILED DESCRIPTION OF PREFERRED EMBODIMENTS

The preferred embodiments of the present invention are described in detail below with reference to the accompanying drawings.

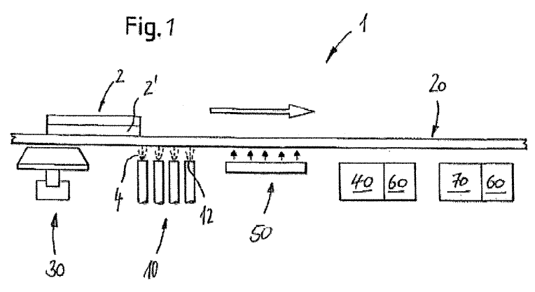

FIG. 1 schematically shows a coating device 1 as a preferred embodiment of the present invention. The device is used for coating and, optionally, also for decorating workpieces 2, which can be, e.g., flooring panels, consisting at least partially of wood, wood-based materials, synthetic material or, optionally, also varnish or the like. It should be noted, however, that the device 1 according to the invention is also suitable for coating different workpieces 2, even though the device is primarily intended for the applications mentioned above.

In the present embodiment, the device 1 comprises a conveyor means 20 which is designed as conveyor belt or conveyor table and can convey the respective workpieces 2 in a transport direction indicated by an arrow. Although the present embodiment thus relates to a so-called through-put machine, it should be noted that the respective workpiece can also be arranged in a stationary manner. In this case, those components of the device that perform machining of the workpiece could and would have to be moved with respect to the workpiece. Mixed forms of both embodiments are also possible within the scope of the invention.

In the present embodiment, several machining components are arranged along the conveyor means 20, i.e. firstly a machining means, not shown in detail, for machining the workpiece by way of cutting such as, for instance, a milling unit, then a smoothing means 30 for smoothing a surface 2′ of the respective workpiece 2 machined by the machining means, an application means 10 for applying a curable mass 4, an NIR-curing means 50, an ink-jet printing means 40, a UV-curing means 60, a coating-varnish application means 70 and a further UV-curing means 60. The device 1 is thereby designed such that depending on the respective requirements, either all of the cited components or, optionally, also only one or more components perform machining of the workpiece 2 that is passing through. To achieve this, the respective components are connected to a control means, not shown in detail, which is capable of automatically controlling the operation of the individual components depending on the requirements.

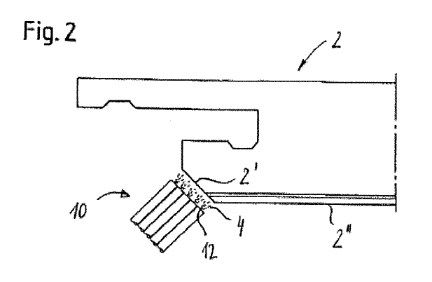

In the present embodiment, the application means 10 has, as can also be seen in FIG. 2, a plurality of micro-nozzles 12 for applying the curable mass 4, e.g. a varnish, to the surface 2′ of the respective workpiece. As best seen in FIG. 2, the micro-nozzles 12 are adapted as regards their inclination to the alignment of the surface 2′ to be coated and can also be arranged so as to be pivotable and/or rotatable for this purpose. Although it is not shown in more detail in the figures, a micro-valve is allocated to each micro-nozzle 12, said micro-valve being connected to a pressurized store of curable mass, which is not shown either, such that a predetermined amount of curable mass can be ejected out of the respective micro-nozzles 12 by opening the micro-valve. The opening and closing of the micro-valve 12 can also be performed by the control device, not shown, or corresponding electric pulses. The micro-valves 12 can, e.g., be solenoid micro-valves.

In the present embodiment, the micro-nozzles have a diameter in the range of about 100 μm to 200 μm, although the present invention is not restricted thereto. In the present embodiment, 20 micro-nozzles are provided, purely as an example, in an even arrangement, the number of micro-nozzles and their (optionally displaced) arrangement being able to be adapted to the respective requirements in different ways.

The smoothing means 30 provided upstream of the application means 10 is designed in the present embodiment as a thermal-transfer smoothing means. It is thus, in principle, a heated, smooth surface that is slidingly pressed against the workpiece surface 2′. However, the smoothing means can also be designed in a completely different manner and, for instance, cause precision sanding of the surface 2′.

The application means 10 is followed by the NIR-curing means 50, which in the present embodiment is designed for curing a varnish applied by the application means 10. The curing means 50 can, of course, be adapted to the requirements of different coating materials.

This is followed by the ink-jet printing means 40, which is designed to apply a desired print image, such as a wood grain or the like to the applied coating material 4. This is in turn followed by a UV-curing means 60, which is designed to cure and/or dry the ink applied by the ink-jet printing means 40.

Finally, there is a subsequent varnish application means 70 for additionally sealing, in case of very high-quality products, the print image of the ink-jet printing means 40 by means of, e.g., a wear-resistant clear ink or a varnish and, finally, to cure and/or dry by way of a further UV-curing means 60.

During operation of the device 1 according to the invention, a workpiece 2 is guided along to the different components of the device 1 using the conveying means 20, and individual or several of the machining operations described above are performed on the workpiece 2 or the surface 2′ to be treated according to the requirements.

1-14. (canceled)

15. A device for coating wood, wood-containing, or synthetic workpieces comprising:
a curable mass; and
a conveying means for causing a relative movement between said application means and the respective workpiece, wherein said application means comprises at least one micro-nozzle for applying the curable mass.

16. The device according to claim 15, wherein said application means comprises at least one pressurized store of curable mass.

17. The device according to claim 16, wherein the device comprises at least one micro-valve per micro-nozzle.

18. The device according to claim 16, wherein the at least one micro-valve is arranged between said at least one store and said at least one micro-nozzle.

19. The device according to claim 15, wherein said at least one micro-nozzle has a diameter of at least 50 μm.

20. The device according to claim 15, wherein said at least one micro-nozzle has a maximum diameter of 300 μm.

21. The device according to claim 15, further comprising:
a plurality of micro-nozzles which are arranged in an offset manner in the direction of a relative movement between said application means and the respective workpiece.

22. The device according to claim 15, further comprising:
a smooth surface of the respective workpiece which is to be provided with said curable mass.

23. The device according to claim 15, further comprising:
a machining means for machining the respective work-piece by way of cutting.

24. The device according to claim 15, further comprising:
an ink jet printer.

25. The device according to claim 15, further comprising:
at least one UV-curing means and/or at least one NIR-curing means.

26. A process for coating workpieces using a device according to claim 15, said process comprising the steps of:
providing a workpiece comprising at least partially of wood, wood-based materials, or synthetic materials; and
coating said workpiece with a curable mass.

27. The process according to claim 26, wherein said workpiece is machined by way of cutting, wherein said workpiece is smoothened on the surface, wherein said pretreated region is coated at least in sections with said curable mass.

28. The process according to claim 27, wherein said workpiece is plate-shaped or strip-shaped, and wherein at least a narrow surface of said workpiece is coated with said curable mass in sections, wherein said narrow surface is at an angle with respect to a large surface of said workpiece.

29. The device according to claim 15, wherein said curable mass is a varnish.

30. The device according to claim 17, wherein said micro-valve is a solenoid micro-valve.

31. The device according to claim 17, wherein the at least one micro-valve is arranged between said at least one store and said at least one micro-nozzle.

32. The device according to claim 15, wherein said at least one micro-nozzle has a diameter of at least 100 μm.

33. The device according to claim 15, wherein said at least one micro-nozzle has a maximum diameter of 200 μm.

34. A device according to claim 15, further comprising:
at least one ink jet printer.
